(19) United States
(12) Patent Application Publication
(10) Pub. No.: US 2016/0246902 A1
(43) Pub. Date: Aug. 25, 2016

(54) Methods for Processing a Computer Simulation Program and Computer Program Product for Implementing Such a Method

(71) Applicant: Synopsys, Inc., Mountain View, CA (US)

(72) Inventor: Ulrich Holtmann, Herzogenrath (DE)

(21) Appl. No.: 15/005,782

(22) Filed: Jan. 25, 2016

(30) Foreign Application Priority Data
Feb. 19, 2015 (DE) 102015102362.8

(51) Int. Cl. G06F 17/50

(52) U.S. Cl. CPC G06F 17/5009

(57) ABSTRACT

A method for processing a computer simulation program is provided. The method comprises initiating and performing a first portion of operational process steps of the simulation program on a first processor unit of a computer. The method further comprises initiating and performing a first subsequence of process steps on a second processor unit of the computer. Therein, the first subsequence comprises the first portion of operational process steps and a first portion of non-operational process steps of the simulation program.

### BACKGROUND OF THE INVENTION

The disclosure relates to methods for processing a computer simulation program on a computer, in particular a computer with a plurality of processor units, and to a computer program product for implementing such a method.

In the area of computer simulations, tasks or process steps of a computer simulation program can often be split into two groups: Operational tasks or process steps and non-operational tasks or process steps. Operational tasks may for example repeatedly compute how one simulation state evolves into another simulation state of a simulated system. Non-operational tasks may for example not change the simulation state but provide additional data.

Operational tasks may be mandatory. On the other hand, non-operational tasks may be optional, useful for example for debugging and validation purposes but may require additional computation time. Thus, according to existing concepts, an overall turnaround time, TAT, until the simulation completes may be increased significantly due to the non-operational tasks. The overhead, that is the increase of the TAT, due to the non-operational tasks is a disadvantage of existing concepts.

For example, a debugging of a complex hardware model may require a TAT of one hour if non-operational tasks are omitted or disabled but otherwise for example a TAT of 3 hours may be required.

Existing solutions making use of multi-core hosts for reducing the TAT use for example a main process performing only operational tasks. Other processes or process threads may perform only non-operational tasks. However, in such solutions, the main process and the other processes may not be able to run independently for an arbitrarily chosen time interval but may need to synchronize at each simulation step. Consequently, the main process has to frequently pause until all other processes or process threads are done with respective non-operational tasks. This may limit and the available parallelism and a reduction of the TAT.

### SUMMARY OF THE INVENTION

According to the improved concept, a computer simulation program is split into operational process steps and non-operational process steps. While on a first processor unit of the computer only or predominantly operational process steps are performed, non-operational process steps are performed by forked off processes on a second processor unit of the computer. Therein, a certain portion of operational process steps is performed on the second processor unit as well such that on the one hand, the second processor unit can perform non-operational process steps that depend on the portion of operational process steps without relying on output from the first processor unit and, on the other hand, the first processor unit can proceed with the operational process steps without waiting for the non-operational process steps to be finished. In this way, a turnaround time, TAT, of the computer simulation program may be reduced.

According to the improved concept, a method for processing a computer simulation program is provided. The method comprises initiating and performing a first portion of operational process steps of the simulation program on a first processor unit of a computer. The method further comprises initiating and performing a first subsequence of process steps on a second processor unit of the computer. Therein, the first subsequence comprises the first portion of operational process steps and a first portion of non-operational process steps of the simulation program.

In several implementations of the method, the computer simulation program comprises a total number of operational process steps. The total number of operational process steps is divided into a plurality of portions of operational process steps including the first portion of operational process steps. The computer simulation program further comprises a total number of non-operational process steps. The total number of non-operational steps is divided into a plurality of portions of non-operational process steps including the first portion of non-operational process steps. Each of the portions of operational process steps is combined with one of the portions of non-operational process step to form a plurality of subsequences including the first subsequence. Therein, the non-operational process steps of a given subsequence depend on the operational process steps of the given subsequence.

In some implementations of the method, the first portion of operational process steps is initiated and performed on the first processor unit as a part of a main process. The first subsequence is initiated and performed on the second processor unit as a part of a first child process. Therein, the first child process may for example be forked off by the main process.

In various implementations of the method, each of the total number of operational process steps is mandatory for a simulation performed by means of the computer simulation program. The total number of non-operational process steps are optional and may for example be used for debugging or validation of a system that is simulated.

According to some implementations of the method, the first portion of operational process steps and the first subsequence are initiated simultaneously or approximately simultaneously. In some implementations, the main process begins with initiating and performing the first portion of operational process steps and at the same time or approximately at the same time forks off the first child process for initiating and performing the first subsequence.

According to further implementations, the method also comprises, after finishing the performing of the first portion of operational process steps on the first processor unit, initiating and performing a second portion of operational process steps of the simulation program on the first processor unit and initiating and performing a second subsequence of process steps on the second processor unit or on a further processor unit of the computer. Therein, the second subsequence comprises the second portion of operational process steps and a second portion of non-operational process steps of the simulation program.

According to some implementations, the method further comprises determining whether the second processor unit or the further processor unit is available after finishing the performing of the first portion of operational process steps on the first processor unit before initiating and performing the second portion of operational process steps and the second subsequence of process steps. The method further comprises, depending on a result of the determination whether the second processor unit or the further processor unit of the computer is available, pausing the first processor unit before the initiating and performing of the second portion of operational process steps or initiating and performing the second portion of operational process steps without a pausing of the first processor unit.

According to some implementations, the method further comprises determining a total number of processor units, in particular available processor units, of the computer and, depending on the number of processor units and/or on a period required for the performing of the first subsequence, pausing the first processor unit before the initiating and performing of the second portion of operational process steps or initiating and performing the second portion of operational process steps without a pausing of the first processor unit.

Therein, the total number of available processor units for example corresponds to a total number of processor units that are available for processing the computer simulation program.

According to further implementations, the method also comprises, after finishing the performing of the second portion of operational process steps on the first processor unit, initiating and performing a third portion of operational process steps of the simulation program on the first processor unit and initiating and performing a third subsequence of process steps on the second processor unit, the further processor or an additional processor unit of the computer. Therein, the additional processor unit may be given by the second processor unit or the further processor unit. Alternatively, the additional processor unit may not be given by the second processor unit or the further processor unit. The third subsequence comprises the third portion of operational process steps and a third portion of non-operational process steps of the simulation program.

In some implementations of the method, the second portion of operational process steps and the second subsequence are initiated simultaneously or approximately simultaneously.

According to some implementations of the method, the first processor unit is paused after the performing of the first portion of operational process steps is finished if all processor units of the computer except for the first processor unit are busy.

In several implementations, the method further comprises terminating the first subsequence after a specified interval of simulation time. The interval of simulation time may for example correspond to a total time period used by the first subsequence for performing the operational process steps of the first portion of operational process steps. In particular, time used by the first subsequence for performing non-operational process steps may for example not contribute to the interval of simulation time. Consequently, a total time used by the first subsequence may be longer than the interval of simulation time. In some implementations, the method further comprises terminating the second subsequence and/or further subsequences of process steps after a specified further interval of simulation time, wherein the further interval of simulation time may be equal to or different from the interval of simulation time. In particular, the further interval of simulation time may for example correspond to a total time period used by the second subsequence for performing the operational process steps of the second portion of operational process steps.

According to several implementations of the method, each of the process steps of the first portion of operational process steps generates a simulation state of a simulated system based on a previous simulation state of the simulated system or on an initial state of the simulated system. Analogously, according to several implementations of the method, each of the process steps of the second portion of operational process steps generates a simulation state of the simulated system based on a previous simulation state of the simulated system or on an initial state of the simulated system. The same may hold for further portions of operational process steps. The analog may hold for further portions of operational process steps.

In some implementations of the method, first non-operational data are generated by the first portion of operational process steps and the first non-operational data are processed by the first portion of non-operational process steps. Accordingly, in respective implementations of the method, second non-operational data are generated by the second portion of operational process steps and the second non-operational data are processed by the second portion of non-operational process steps. The analog may hold for the further portions of operational process steps and further portions of non-operational process steps, respectively.

In several implementations of the method, the processing of the first non-operational data comprises at least one of the following: dumping at least a part of the first non-operational data and/or data derived from the first non-operational data into a first dump file and/or a first trace file, evaluating an assertion based on the non-operational data and evaluating a coverage, in particular a line coverage and/or a functional coverage, based on the non-operational data. The analog may hold for the second non-operational data and/or further non-operational data, respectively.

According to further implementations of the method, the processing of the first non-operational data comprises storing a result from the first portion of non-operational process steps into a first non-operational file. The first non-operational file may for example be given by the first dump file, the first trace file and/or another file. The analog may hold for the second non-operational data and/or further non-operational data with respect to a second non-operational file and/or further non-operational files, respectively.

In various implementations of the method, the computer simulation program processes a hardware description language, HDL, and is configured to simulate an electronic circuit.

In several implementations, the method further comprises setting up a non-operational infrastructure including an infrastructure for the first portion of non-operational process steps and/or including an infrastructure for the second portion of non-operational process steps.

The non-operational infrastructure may in particular be set up by the main process before the initiation and performing of the first portion of operational process steps.

In some implementations of the method, the method is performed by means of a circuit design tool, in particular by an electronic design automation, EDA, tool.

According to the improved concept also a method for processing a computer simulation program is provided, wherein the method comprises initiating and performing a main process of the simulation program on a first processor unit of a computer, the main process comprising operational process steps. The method further comprises periodically initiating and performing child processes on a second processor unit of the computer and/or on a further processor unit of the computer, wherein each of the child processes inherits a respective simulation state of a simulated system from the main process, each of the child processes comprises a part of the operational process steps and corresponding non-operational process steps and the corresponding non-operational steps are not comprised by the main process.

Further implementations of the method are readily derived by combining different described implementations of the method. In particular, the first, the second and further portions of operational process steps may be comprised by the main process, while the first, the second and further subsequences of process step may be comprised by the child processes.

According to further implementations, except for a setting up of on infrastructure for the non-operational process steps, the main process comprises no non-operational steps or a reduced amount of non-operational steps.

In some implementations of the method, the method is performed by means of a circuit design tool, in particular by an electronic design automation, EDA, tool.

According to the improved concept, also a computer program product is provided, wherein the computer program product comprises a code, said code being configured to implement a method according to the improved concept, in particular when being performed on a computer with respective processing units. The code may for example be stored on a storage device.

According to some implementations of the computer program product, the computer program product comprises a computer-readable storage medium, in particular a tangible and non—transitory computer-readable storage medium, and a computer program module stored therein, said computer program module containing instructions for processing a computer simulation program. When the computer program module is being executed by a computer the instructions cause the computer to initiate and perform a first portion of operational process steps of the simulation program on a first processor unit of the computer. The instructions cause the computer further to initiate and perform a first subsequence of process steps on a second processor unit of the computer, wherein the first subsequence comprises the first portion of operational process steps and a first portion of non-operational process steps of the simulation program.

Further implementations of the computer program product are readily derived from the various implementations of the method according to the improved concept.

According to the improved concept, also a computer system is provided. The computer system comprises at least a first and a second processor unit, a memory and a computer program module, the computer program module being stored in the memory and containing instructions for processing a computer simulation program. The computer system is configured to execute the computer program module, wherein when the computer program module is being executed by the computer system, the instructions cause the computer system to initiate and perform a first portion of operational process steps of the simulation program on the first processor unit. The instructions cause the computer system further to initiate and perform a first subsequence of process steps on the second processor unit of the computer, wherein the first subsequence comprises the first portion of operational process steps and a first portion of non-operational process steps of the simulation program.

Further implementations of the computer program product are readily derived from the various implementations of the method or the computer program product according to the improved concept.

In the following, the invention is explained in detail with the aid of exemplary implementations by reference to the drawings. Components and items that are functionally identical, have an identical effect or correspond to each other may be denoted by identical references.

Such components and items may be described only with respect to the figure where they occur first; their description is not necessarily repeated in subsequent figures.

### BRIEF DESCRIPTION OF THE DRAWINGS

FIG. 1 shows a simplified representation of an illustrative integrated circuit design flow;

FIG. 2 shows a representation of an exemplary implementation of a method according to the improved concept;

FIG. 3 shows a representation of a further exemplary implementation of a method according to the improved concept; and

FIG. 4 shows a representation of a further exemplary implementation of a method according to the improved concept.

### DETAILED DESCRIPTION

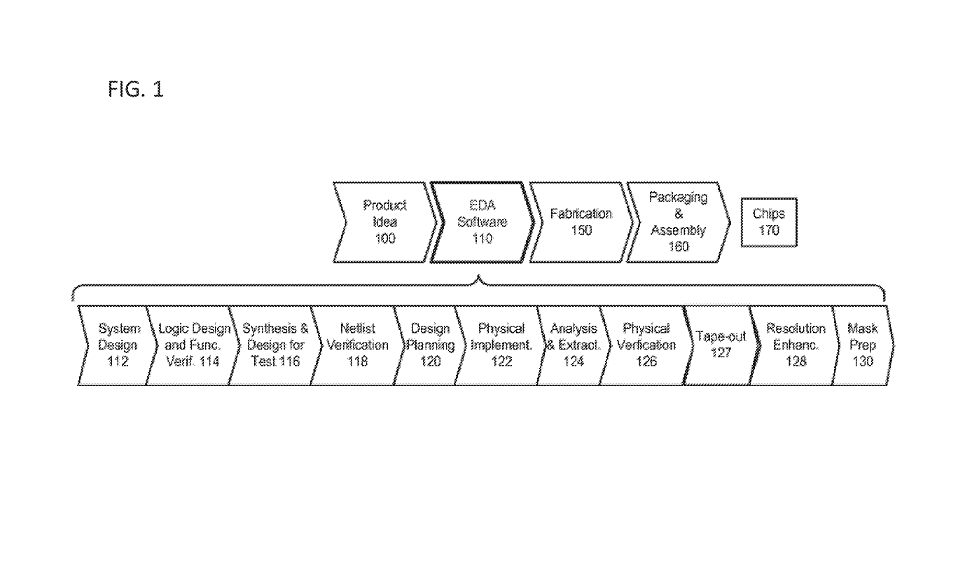

FIG. 1 shows a simplified representation of an illustrative design flow for designing an electronic circuit in particular an integrated circuit, IC. An implementation of a method according to the improved concept may for example be embedded within such design flow. However, an implementation of a method according to the improved concept may also be utilized within another design flow or independently from a design flow.

At a high level, the process starts with the product idea (step 100) and is realized in an Electronic Design Automation, EDA, software design process (step 110). When the design is finalized, it can be taped-out (step 127). At some point after tape-out, the fabrication process (step 150) and packaging and assembly processes (step 160) occur, resulting ultimately in finished IC chips (result 170).

The EDA software design process (step 110) itself is composed of a number of steps 112-130, shown in linear fashion for simplicity. In an actual integrated circuit design process, the particular design might have to go back through steps until certain tests are passed. Similarly, in any actual design process, these steps may occur in different orders and combinations. This description is therefore provided by way of context and general explanation rather than as a specific, or recommended, design flow for a particular integrated circuit.

A brief description of the component steps of the EDA software design process (step 110) is provided.

System design (step 112): Designers describe functionalities they want to implement. They may perform what-if planning to refine functionality, check costs, etc. Hardware-software architecture partitioning may be carried out at this stage. Example EDA software products from Synopsys, Inc. that can be used at this step include Model Architect, Saber, System Studio, and DesignWare® products.

Logic design and functional verification (step 114): At this stage, a VHDL, SystemVerilog or Verilog code for modules in the system is written and the design is checked for functional accuracy. More specifically, the design is checked to ensure that it produces correct outputs in response to particular input stimuli. Example EDA software products from Synopsys, Inc. that can be used at this step include VCS, VERA, DesignWare®, Magellan, Formality, ESP and LEDA products. Aspects of the invention may be performed during this step 114.

Synthesis and design for test (step 116): Here, the VHDL/Verilog is translated to a netlist. The netlist can be optimized for the target technology. Additionally, the design and implementation of tests to permit checking of the finished chip occurs. Example EDA software products from Synopsys, Inc. that can be used at this step include Design Compiler®, Physical Compiler, DFT Compiler, Power Compiler, FPGA Compiler, TetraMAX, and DesignWare® products.

Netlist verification (step 118): At this step, the netlist is checked for compliance with timing constraints and for correspondence with the VHDL/Verilog source code. Example EDA software products from Synopsys, Inc. that can be used at this step include Formality, PrimeTime, and VCS products.

Design planning (step 120): Here, an overall floorplan for the chip is constructed and analyzed for timing and top-level routing. Example EDA software products from Synopsys, Inc. that can be used at this step include Astro and Custom Designer products.

Physical implementation (step 122): The placement (positioning of circuit elements) and routing (connection of the same) is carried out in this step (place-and-route process). Example EDA software products from Synopsys, Inc. that can be used at this step include the Astro, IC Compiler, and Custom Designer products.

Analysis and extraction (step 124): In this step, the circuit function is verified at a transistor level, in turn permitting what-if refinement. Example EDA software products from Synopsys, Inc. that can be used at this step include AstroRail, PrimeRail, PrimeTime, and Star-RCXT products.

Physical verification (step 126): At this step various checking functions are performed to ensure correctness for: manufacturing, electrical issues, lithographic issues, and circuitry. Example EDA software products from Synopsys, Inc. that can be used at this step include the Hercules product.

Tape-out (step 127): This step provides the “tape-out” data to be used (after lithographic enhancements are applied if appropriate) for production of masks for lithographic use to produce finished chips. Example EDA software products from Synopsys, Inc. that can be used at this step include the IC Compiler and Custom Designer families of products.

Resolution enhancement (step 128): This step involves geometric manipulations of the layout to improve manufacturability of the design. This step for example includes optical proximity correction, OPC. Example EDA software products from Synopsys, Inc. that can be used at this step include Proteus, ProteusAF, and PSMGen products.

Mask data preparation (step 130): This step provides mask-making-ready “tape-out” data for production of masks for lithographic use to produce finished chips. Example EDA software products from Synopsys, Inc. that can be used at this step include the CATS(R) family of products. Often this step includes partitioning or fracturing non-rectangular shaped islands into rectangles.

As mentioned, aspects of the invention may be performed during logic design and functional verification (step 114). However, it may also be suitable to perform aspects of the invention during other steps of the EDA process or during steps of another circuit design process.

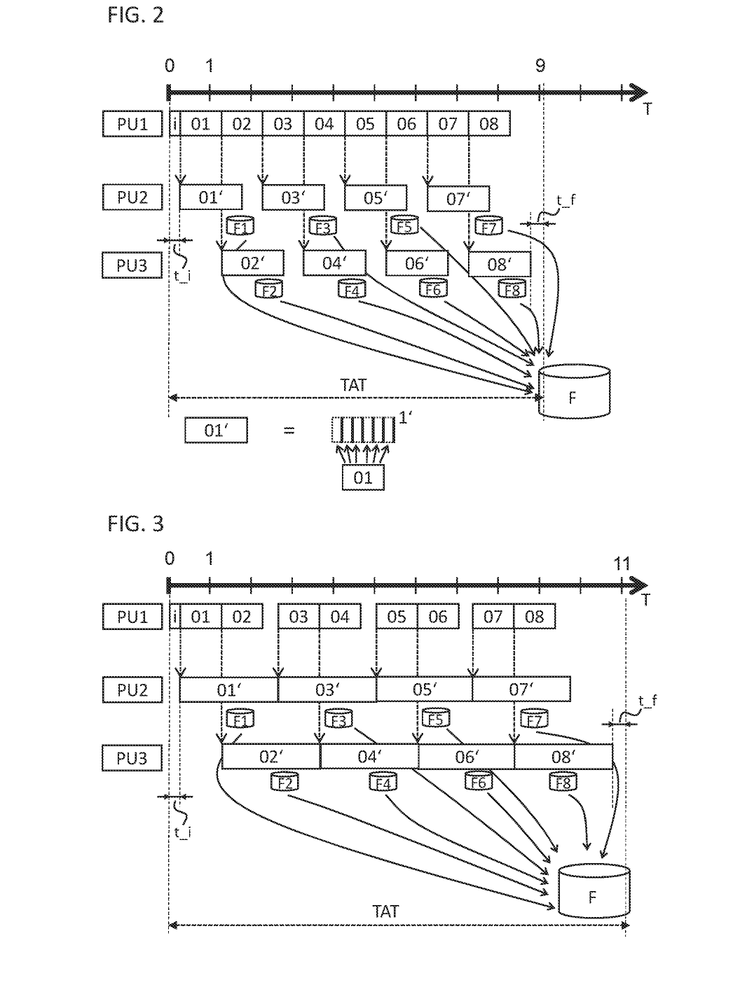

FIG. 2 shows a representation of an exemplary implementation of a method according to the improved concept.

Shown are schematically a first processor unit PU1, a second processor unit PU2 and a third processor unit PU3 of a computer as well as a timeline T with arbitrary time units. FIG. 2 displays several portions of operational process steps 01, 02, . . . , 08 of a simulation program that are initiated and performed on the first processor unit PU1 and an infrastructure sequence i. Furthermore, several subsequences of process steps 01′, 03′, 05′, 07′ that are initiated and performed on the second processor unit PU2 as well as several subsequences of process steps 02′, 04′, 06′, 08′ that are initiated and performed on the third processor unit PU3 are shown. Additionally, FIG. 2 shows several non-operational files F1, F2, . . . , F8 and a collecting file F.

The first, the second and the third processor unit PU1, PU2, PU3 of the computer are for example given by a first, a second and a third processor, by a first, a second and a third central processor unit, CPU, by a first, a second and a third processor core of a processor or CPU, by a first, a second and a third co-processor, or by a combination of those.

At the beginning of the displayed method, the infrastructure sequence i is initiated and performed on the first processor unit PU1. During the infrastructure sequence i, a non-operational infrastructure is set up including infrastructures for the subsequences 01′, 02′, . . . , 08′. The time required for performing the infrastructure sequence i is given by an infrastructure time t_i. By means of the infrastructure sequence, for example assignments, directions or details concerning a performing of the subsequences 01′, 02′, . . . , 08′ may be specified.

It is pointed out that a total number of the portions of operational process steps 01, 02, . . . , 08 and/or a total number of the subsequences 01′, 02′, . . . , 08′ is not necessarily known at the beginning of the method. Analogously, a length or a time period of each of the portions of operational process steps 01, 02, . . . , 08 and/or a length or a time period of each of the subsequences 01′, 02′, . . . , 08′ is not necessarily known at the beginning of the method. Consequently, in such cases the infrastructure sequence i may set up the non-operational infrastructure including infrastructures for an unknown total number and/or for an unknown length or time period of the subsequences 01′, 02′, . . . , 08′.

After the infrastructure sequence i has finished, the first portion of operational process steps 01 is initiated and performed on the first processor unit PU1. Simultaneously or approximately simultaneously, the first subsequence of process steps 01′ is initiated and performed on the second processor unit PU2.

In particular, the first portion of operational process steps 01 may be part of a main process running on the first processor unit PU1. The main process for example forks off a first child process running on the second processor unit PU2 and comprising the first subsequence 01′. Thereby, the first child process may inherit a simulation state of a simulated system from the main process. In the described case of the first child process comprising the first subsequence 01′ the simulated state may for example be an initial state of the simulated system.

Therein, the first subsequence 01′ comprises the first portion of operational process steps 01 and a first portion of non-operational process steps of the simulation program. The operational process steps of the first portion 01 and the first portion of non-operational process steps may be interleaved within the first subsequence 01′. For example, each of the first portion of non-operational process may be performed after a corresponding operational process step of the first portion 01. This is schematically displayed in the lower part of FIG. 2. The first subsequence 01′ is represented by an alternating sequence of operational process steps corresponding to the first portion of operational steps 01, indicated by blank slices with dotted edges, and non-operational process steps corresponding to the first portion of non-operational process steps, indicated by filled slices. The same holds mutatis mutandis for the remaining subsequences 02′, . . . , 07′, 08′ and the remaining portions of operational process steps 02, . . . , 07, 08, respectively.

This means that, when the first subsequence 01′ is performed, actually all operational process steps comprised by the first portion of operational process steps 01 are performed and between the operational process steps, the non-operational process steps comprised by the first portion of non-operational process steps are performed. In particular, this is in contrast to the performing of the first portion of operational process steps 01 on the first processor unit PU1, where the operational process steps comprised by the first portion 01 are performed one after another without being interrupted by non-operational process steps. That means, for the main process, in particular for the performing of the first portion 01 on the first processor unit PU1, non-operational process steps are for example disabled.

In the shown example, all operational process steps of the first portion 01 feature the same time period, and all non-operational process steps of the first portion of non-operational process steps feature the same time period. In alternative implementations, the operational process steps of the first portion 01 may not feature the same time period and/or all non-operational process steps of the first portion of non-operational process steps may not feature the same time period.

In further implementations, not every operational process step of the first portion 01 may be followed by a non-operational process step, in contrast to the example shown in the lower part of FIG. 2. It is highlighted that the number of slices representing the first portion of operational steps 01 and the non-operational process steps of the first portion of non-operational process steps being equal to six, respectively, is chosen only for explanatory reasons and may be different in other implementations.

The operational process steps of the first portion 01 may for example generate first non-operational data. The first non-operational data are then processed by the first portion of non-operational process steps. This may for example comprise a dumping of the first non-operational data or a part of the first non-operational data into the first non-operational file F1. The first non-operational file F1 may then for example be a dump file or a trace file.

After the first subsequence 01′ has finished, the first child process is for example terminated. Therein, the termination may be determined for example by a specified interval of simulation time. The interval of simulation time may for example correspond to a total time period used by the first child process for performing the operational process steps of the first portion 01. In particular, time used by the first child process for performing non-operational process steps may not contribute to the interval of simulation time. The interval of simulation time may for example lie in the order of μs, for example 1 μs. However, different intervals of simulation time are obviously possible, depending for example on the implementation of the method, the computer simulation program and the simulated system.

After the first portion of operational process steps 01 has finished, the second portion of operational process steps 02 is initiated and performed on the first processor unit PU1. Simultaneously or approximately simultaneously the second subsequence of process steps 02′ is initiated and performed on the third processor unit PU3. What has been described above for the first portion of operational process steps 01 and the first subsequence 01′ holds analogously also for the second portion of operational process steps 02 and the first subsequence 02′, respectively.

In particular, the second portion of operational process steps 02 may be part of the main process and the main process for example forks off a second child process running on the third processor unit and comprising the second subsequence 02′. Thereby, the second child process may inherit a simulation state of the simulated system from the main process. The simulation state inherited by the second child process may for example be a state of the simulated system after finishing the first portion of operational process steps 01.

The second subsequence 02′ comprises the second portion of operational process steps 02 and a second portion of non-operational process steps of the simulation program. The operational process steps of the second portion 02 and the second portion of non-operational process steps may be interleaved within the second subsequence 02′, as explained with respect to the lower part of FIG. 2 for the first subsequence 01′.

In analogy to the above said, the operational process steps of the second portion 02 may generate second non-operational data. The second non-operational data are processed by the second portion of non-operational process steps. The processing of the second non-operational data may for example comprise a dumping of the second non-operational data or a part of the second non-operational data into the second non-operational file F2.

In an analog way as described above, the method proceeds with performing the remaining portions of operational process steps 03, 04, . . . , 08 on the first processor unit PU1 and the remaining subsequences 03′, 04′, . . . , 08′ alternatingly on the second and the third processor unit PU2, PU3. The remaining subsequences 03′, 04′, . . . , 08′ comprise the remaining portions of operational process steps 03, 04, . . . , 08, respectively, and respective portions of non-operational process steps of the simulation program. Therein, the operational process steps of the remaining portions 03, 04, . . . , 08 and the respective portions of non-operational process steps may be interleaved within the remaining subsequences 03′, 04′, . . . , 08′, respectively, as explained with respect to the lower part of FIG. 2 for the first subsequence 01′.

In particular, the subsequences 01′, 02′, . . . , 08′ may be comprised by respective child processes being forked off by the main process at respective instances and inheriting respective states of the simulation from the main process. The child processes may be copies of the main process, wherein, in contrast to the main process, a performing of the non-operational process steps is enabled and that are terminated after specified respective intervals of simulation time as described above with respect to the first subsequence 01′.

A content of the non-operational files F1, F2, . . . , F8 are stored into the collecting file F. In some implementations, the storing may be performed continuously during the described method. In alternative implementations, the storing is performed after the last subsequence, being the eighth subsequence 08′ in the shown case, has finished.

In the shown example, the turnaround time, TAT, is slightly longer than 9 time units, wherein the infrastructure time t_i and a finishing time t_f are included. The finishing time t_f corresponds for example to a time needed for storing a content of the eighth non-operational file F8 into the collecting file F. In implementations where the storing of the non-operational files F1, F2, . . . , F8 into the collecting file F is performed after the last subsequence has finished, the finishing time t_f may also correspond to a time needed for storing contents of all non-operational files F1, F2, . . . , F8 into the collecting file F.

In several implementations, an operational process step depends on another operational step being performed earlier or on an initial state of the simulated system. In particular, an initial operational process step of the first portion 01 may depend on the initial state of the simulated system. Further, an initial operational process step of the second portion 02 may depend on a final operational process step of the first portion 01. Analogously, an initial operational process step of the third portion 03 may depend on a final operational process step of the second portion 02 and so forth.

An initial operational process step of the first subsequence 01′ may be identical to the initial operational process step of the first portion 01, an initial operational process step of the second subsequence 02′ may be identical to the initial operational process step of the second portion 02 and so forth.

Consequently, the second subsequence 02′ may for example only be initiated when the first portion 01 is finished on the first processor unit PU1, the third subsequence 03′ may for example only be initiated when the second portion 02 is finished on the first processor unit PU1 and so forth. Therefore, it may depend on a total number of processor units, in particular a total number of available processor units, of the computer, as well as on a time period of the subsequences 01′, 02′, . . . , 08′, whether a given one of the subsequences 01′, 02′, . . . , 08′ and a respective one of the portions 01, 02, . . . , 08 may be initiated simultaneously without a pausing of the first processor unit PU1.

In the shown example, each of the subsequences 01′, 02′, . . . , 08′ has a time period that is for example approximately 1.5 times a time period of one of the portions of operational process steps 01, 02, . . . , 08. Consequently, whenever one of the portions 01, 02, . . . , 08 is finished on the first processor unit PU1, the processor unit on which the simultaneously initiated subsequence was performed is still busy while the remaining of the processor units PU2, PU3 is not busy. Therefore, a following of the portions 01, 02, . . . , 08 may be initiated simultaneously with and performed on the first processor unit PU1 as well as a following of the subsequences 01′, 02′, . . . , 08′ without a pausing of the first processor unit PU1 being necessary.

For example, when the first portion 01 is finished on the first processor unit PU1, the second processor unit PU2 is busy while the third processor unit PU3 is not busy. Consequently, the second portion 02 may be initiated on the first processor unit PU1 simultaneously with the second subsequence 02′ being initiated on the third processor unit PU3 without a pausing of the first processor unit PU1. Further, when the second portion 02 is finished on the first processor unit PU1, the third processor unit PU3 is busy while the second processor unit PU2 is not busy. Consequently, the third portion 03 may be initiated on the first processor unit PU1 simultaneously with the third subsequence 03′ being initiated on the second processor unit PU2 without a pausing of the first processor unit PU1 and so forth.

In alternative implementations, pauses of the first processor unit PU1 between some of the portions 01, 02, . . . , 08 may be necessary.

In alternative implementations of the method, the portions 01, 02, . . . , 08 may not all have the same time period. It is also pointed out that the number of the portions of operational process steps 01, 02, . . . , 08 and the number of the subsequences 01′, 02′, . . . , 08′ is eight here for exemplary reasons only and can be larger or smaller than eight.

In the described method, the main process runs independent from the child processes and vice versa, apart from the inheritance of states of the simulated system. In further implementations of the method, the subsequences 01′, 02′, . . . , 08′ may have a different time period than 1.5 time units and also may not all have the same time period.

The computer simulation program may for example be a program for simulation of electronic or electric circuits, for example a hardware circuit simulation using a hardware description language, HDL. Examples for the HDL are SystemVerilog, Verilog or another HDL. However, the computer simulation program may also be a program for simulation of physical or chemical or other processes or systems.

In the case of an hardware circuit simulation, the first and the second non-operational data as well as non-operational data generated by the remaining portions of operational process steps 03, 04, . . . , 08 may for example comprise signal levels of the hardware circuit, for example related to a waveform of the hardware circuit, data for evaluating assertions of the computer simulation program and/or data for evaluating a coverage of the computer simulation program. The coverage may in particular be a line coverage or a functional coverage.

The operational process steps of the portions 01, 02, . . . , 08 may for example correspond to HDL statements, for example Verilog statements, computing a next-state value of registers or updating registers on a clock edge.

FIG. 3 shows a representation of a further exemplary implementation of a method according to the improved concept.

The implementation displayed in FIG. 3 is based on the implementation of FIG. 2. A total number of processor units is three as for the example of FIG. 2. A difference to FIG. 2 is that the time period of each of the subsequences 01′, 02′, . . . , 08′ is for example given by approximately 2.5 times the time period of each of the portions of operational process steps 01, 02, . . . , 08.

Consequently, whenever one of the second, the fourth and the sixth portion 02, 04, 06 is finished on the first processor unit PU1, the second and the third processor unit PU2, PU3 are both busy. Therefore, the first processor unit PU1 is paused until the second processor unit PU2 is not busy anymore. Then, a respective one of the third, the fifth and the seventh portion 03, 05, 07 is initiated and performed on the first processor unit PU1 and a respective one of the third, the fifth and the seventh subsequence 03′, 05′, 07′ is initiated and performed on the second processor unit PU2.

In the shown example, the turnaround time, TAT, is slightly longer than 11 time units including the infrastructure time t_i and the finishing time t_f.

It is pointed out that the pausing of the first processor unit PU1 in the implementation of FIG. 3 may be necessary due to the limited total number of available processor units, being three in the example of FIG. 3. In particular, the initiating and performing of the portions 01, 02, . . . , 08 on the first processor unit PU1 is independent of the subsequences 01′, 02′, . . . , 08′. Thus, the pausing of the first processor unit PU1 does not originate from the fact that one of the subsequences 01′, 02′, . . . , 08′ is not finished yet at a respective time. Instead, the pausing of the first processor unit PU1 may originate from the fact that no further processor unit is available at the respective time.

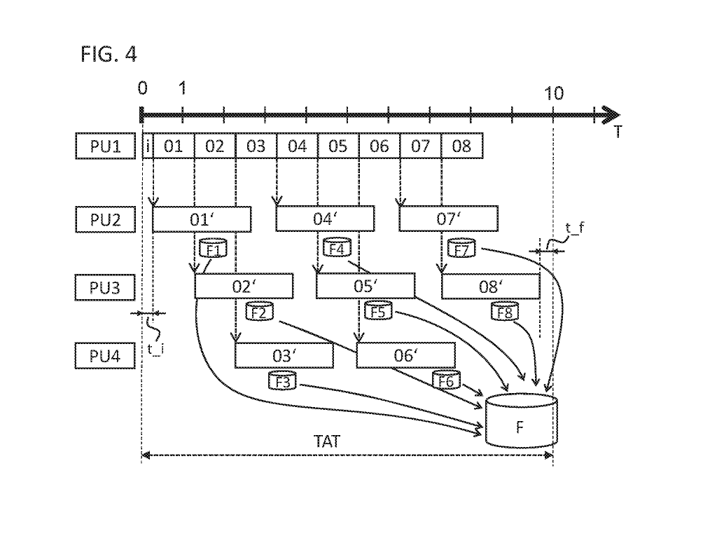

FIG. 4 shows a representation of a further exemplary implementation of a method according to the improved concept.

The implementation displayed in FIG. 4 is based on the implementation of FIG. 3. As in FIG. 3, the time period of each of the subsequences 01′, 02′, . . . , 08′ is for example given by approximately 2.5 times the time period of each of the portions of operational process steps 01, 02, . . . , 08. In FIG. 3, additionally a fourth processor unit PU4 is shown. Consequently, a total number of processor units is four in the example of FIG. 4.

Therefore, whenever one of the third and the sixth portion 03, 06 is finished on the first processor unit PU1, the third and the fourth processor unit P3, P4 are busy, while the second processor unit PU2 is not busy or not busy anymore, respectively. Consequently, a respective one of the fourth and the seventh portion 04, 07 is initiated and performed on the first processor unit PU1 and a respective one of the fourth and the seventh subsequence 04′, 07′ is initiated and performed on the second processor unit PU2.

Further, whenever one of the first, the fourth and the seventh portion 01, 04, 07 is finished on the first processor unit PU1, the third processor unit PU3 is not busy. Consequently, a respective one of the second, the fifth and the eighth portion 02, 05, 08 is initiated and performed on the first processor unit PU1 and a respective one of the second, the fifth and the eighth subsequence 02′, 05′, 08′ is initiated and performed on the third processor unit PU3.

Analogously, whenever one of the second and the fifth portion 02, 05 is finished on the first processor unit PU1, the second and the third processor unit P2, P3 are busy, while the fourth processor unit PU4 is not busy. Consequently, a respective one of the third and the sixth portion 03, 06 is initiated and performed on the first processor unit PU1 and a respective one of the third and the sixth subsequence 03′, 06′ is initiated and performed on the fourth processor unit PU4.

A pausing of the first processor between some of the portions of operational process steps 01, 02, . . . , 08 as for the implementation of FIG. 3 is therefore not necessary in the implementation of FIG. 4.

In the shown example, the turnaround time, TAT, is approximately 10 time units including the infrastructure time t_i and the finishing time t_f.

For implementations of the method according to the improved concept, in particular for the implementations shown in FIGS. 2 to 4 and for implementations not shown, the main process may determine whether a pausing of the first processor unit PU1 between some of the portions of operational process steps 01, 02, . . . , 08 is necessary, as for example in FIG. 3, or is not necessary, as for example in FIGS. 2 and 4. To this end, the main process may for example determine a total number of available processor units Np. The main process may for example receive respective feedbacks from the remaining processor units PU2, PU3, PU4, the feedbacks containing information about the remaining processor units PU2, PU3, PU4 being busy or not at respective points in time.

In general, for implementations where the period of each of the portions 01, 02, . . . , 08 is equal to a period Tp in arbitrary units and the period of each of the subsequences 01′, 02′, . . . , 08′ is equal to a period Ts in the arbitrary units, pauses of the first processor unit PU1 between some of the portions 01, 02, . . . , 08 are not necessary if the following relation holds:

Np≧[Ts/Tp]ᵢ+1. (1)

Therein, [Ts/Tp]ᵢ is equal to the ratio Ts/Tp rounded up to the next larger integer number.

It is highlighted that in several implementations, the periods of each of the subsequences 01′, 02′, . . . , 08′ may not be equal and/or the performing of the portions 01, 02, . . . , 08 or the subsequences 01′, 02′, . . . , 08′ may be disturbed or inhomogeneous. In such implementations, equation (1) may not hold or hold not exactly.

By means of an implementation of the method according to the improved concept, the TAT caused by the non-operational process steps, such as signal dumping, may be reduced, ideally towards zero. In particular, the improved concept may be used for simulation programs where a state of the simulation is defined entirely from read-only files and a memory allocated by the main process. In this way, the improved concept may provide also a scalable option to trade-off TAT versus more hardware usage.

We claim

1. A method for processing a computer simulation program, the method comprising
initiating and performing a first portion of operational process steps of the simulation program on a first processor unit of a computer; and
initiating and performing a first subsequence of process steps on a second processor unit of the computer, wherein the first subsequence comprises the first portion of operational process steps and a first portion of non-operational process steps of the simulation program.

2. The method according to claim 1, wherein the first portion of operational process steps and the first subsequence are initiated simultaneously or approximately simultaneously.

3. The method according to claim 1, further comprising:
after finishing the performing of the first portion of operational process steps on the first processor unit,
initiating and performing a second portion of operational process steps of the simulation program on the first processor unit; and
initiating and performing a second subsequence of process steps on the second processor unit or on a further processor unit of the computer, wherein the second subsequence comprises the second portion of operational process steps and a second portion of non-operational process steps of the simulation program.

4. The method according to claim 3, further comprising,
before initiating and performing the second portion of operational process steps and the second subsequence of process steps, determining whether the second processor unit or the further processor unit is available after finishing the performing of the first portion of operational process steps on the first processor unit; and
depending on a result of the determination, pausing the first processor unit before the initiating and performing of the second portion of operational process steps or initiating and performing the second portion of operational process steps without a pausing of the first processor unit.

5. The method according to claim 3, wherein the second portion of operational process steps and the second subsequence are initiated simultaneously or approximately simultaneously.

6. The method according to claim 3, wherein the first processor unit is paused after the performing of the first portion of operational process steps is finished if all processor units of the computer except for the first processor unit are busy.

7. The method according to claim 1, further comprising terminating the first subsequence of process steps after a specified interval of simulation time.

8. The method according to claim 1, wherein each of the process steps of the first portion of operational process steps generates a simulation state of a simulated system based on a previous simulation state of the simulated system or on an initial state of the simulated system.

9. The method according to claim 1, wherein:
first non-operational data are generated by the first portion of operational process steps; and
the first non-operational data are processed by the first portion of non-operational process steps.

10. The method according to claim 9, wherein the processing of the first non-operational data comprises at least one of the following
dumping at least a part of the first non-operational data and/or data derived from the first non-operational data into a first dump file and/or a first trace file;
evaluating an assertion based on the non-operational data; and
evaluating a coverage, in particular a line coverage and/or a functional coverage, based on the non-operational data.

11. The method according to claim 9, wherein the processing of the first non-operational data comprises storing a result from of the first portion of non-operational process steps into a first non-operational file.

12. The method according to claim 1, wherein the computer simulation program is based on a hardware description language, HDL, and configured to simulate an electronic circuit.

13. The method according to claim 1, further comprising setting up a non-operational infrastructure including an infrastructure for the first portion of non-operational process steps.

14. The method according claim 1, wherein the method is performed by means of a circuit design tool, in particular by an electronic design automation, EDA, tool.

15. A method for processing a computer simulation program, the method comprising
initiating and performing a main process of the simulation program on a first processor unit of a computer, the main process comprising operational process steps;
periodically initiating and performing child processes on a second processor unit of the computer and/or on a further processor unit of the computer, wherein
each of the child processes inherits a respective simulation state of a simulated system from the main process;
each of the child processes comprises a part of the operational process steps and corresponding non-operational process steps; and
the corresponding non-operational process steps are not comprised by the main process.

16. The method according to claim 15, wherein, except for a setting up of an infrastructure for the non-operational steps, the main process comprises no non-operational steps or a reduced amount of non-operational steps.

17. The method according to claim 15, wherein the method is performed by means of a circuit design tool, in particular by an electronic design automation, EDA, tool.

18. A non-transitory computer-readable storage medium storing instructions thereon, the instructions when executed by a processor to process a computer simulation program cause the processor to:
initiate and perform a first portion of operational process steps of the simulation program on a first processor unit of the computer; and
initiate and perform a first subsequence of process steps on a second processor unit of the computer, wherein the first subsequence comprises the first portion of operational process steps and a first portion of non-operational process steps of the simulation program.

19. The computer-readable storage medium according to claim 18, wherein the first portion of operational process steps and the first subsequence are initiated simultaneously or approximately simultaneously.

20. The computer-readable storage medium according to claim 18, wherein when the instruction further cause the processor to:
after finishing the performing of the first portion of operational process steps on the first processor unit,
initiate and perform a second portion of operational process steps of the simulation program on the first processor unit; and
initiate and perform a second subsequence of process steps on the second processor unit or on a further processor unit of the computer, wherein the second subsequence comprises the second portion of operational process steps and a second portion of non-operational process steps of the simulation program.
